(19) United States
(12) Patent Application Publication
(10) Pub. No.: US 2025/0127138 A1
(43) Pub. Date: Apr. 24, 2025

(54) LITTER CONTAINMENT SYSTEM FOR A LITTER BOX

(71) Applicant: Diane Tantardini, Garden Grove, CA (US)

(72) Inventor: Diane Tantardini, Garden Grove, CA (US)

(21) Appl. No.: 18/382,485

(22) Filed: Oct. 21, 2023

(51) Int. Cl. A01K 1/01

(52) U.S. Cl. CPC A01K 1/0107

(57) ABSTRACT

A litter containment system for preventing litter from being moved out of a litter box includes a covering with a pair of curtains which are laterally spaced with respect to each other. The pair of curtains is positionable in a closed configuration wherein inner edges of the pair of curtains lie in abutment with each other. Each one of a plurality of inner magnets is embedded in an associated curtain of the pair of curtains adjacent to the inner edge of the curtain and is oriented to magnetically fasten the pair of curtains in the closed configuration.

### BACKGROUND OF THE INVENTION

### (1) Field of the Invention

The disclosure relates to litter box covers and more particularly pertains to a new litter box cover for preventing litter from being moved out of a litter box.

### (2) Description of Related Art including information disclosed under 37 CFR 1.97 and 1.98

The prior art discloses myriad litter box covers but fails to describe such a cover which comprises curtains with magnets that keep the curtains closed to prevent litter from being removed from the litter box.

### BRIEF SUMMARY OF THE INVENTION

An embodiment of the disclosure meets the needs presented above by generally comprising a covering with a pair of curtains which are laterally spaced with respect to each other. The pair of curtains is positionable in a closed configuration wherein inner edges of the pair of curtains lie in abutment with each other. Each one of a plurality of inner magnets is embedded in an associated curtain of the pair of curtains adjacent to the inner edge of the curtain and is oriented to magnetically fasten the pair of curtains in the closed configuration.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a kit view of a litter containment system according to an embodiment of the disclosure.

FIG. 2 is a front view of a covering of an embodiment of the disclosure.

FIG. 3 is a side in-use view of an embodiment of the disclosure.

FIG. 4 is a perspective in-use view of an embodiment of the disclosure.

FIG. 5 is a front in-use view of an embodiment of the disclosure.

FIG. 6 is a perspective in-use view of an embodiment of the disclosure. A trough is bent to conform to a front end of a litter box.

FIG. 7 is a side in-use view of an embodiment of the disclosure.

FIG. 8 is a top front side perspective view of an embodiment of the disclosure.

FIG. 9 is a bottom front side perspective view of an embodiment of the disclosure.

FIG. 10 is a front in-use view of an embodiment of the disclosure.

FIG. 11 is a cross section view of an embodiment of the disclosure taken from Arrows 11-11 in FIG. 10.

### DETAILED DESCRIPTION OF THE INVENTION

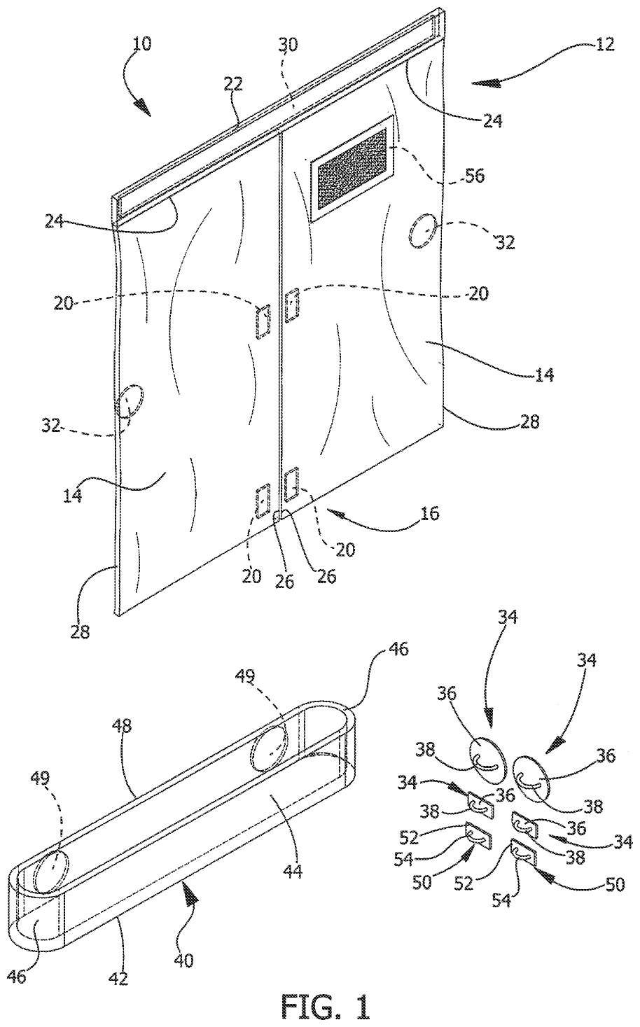

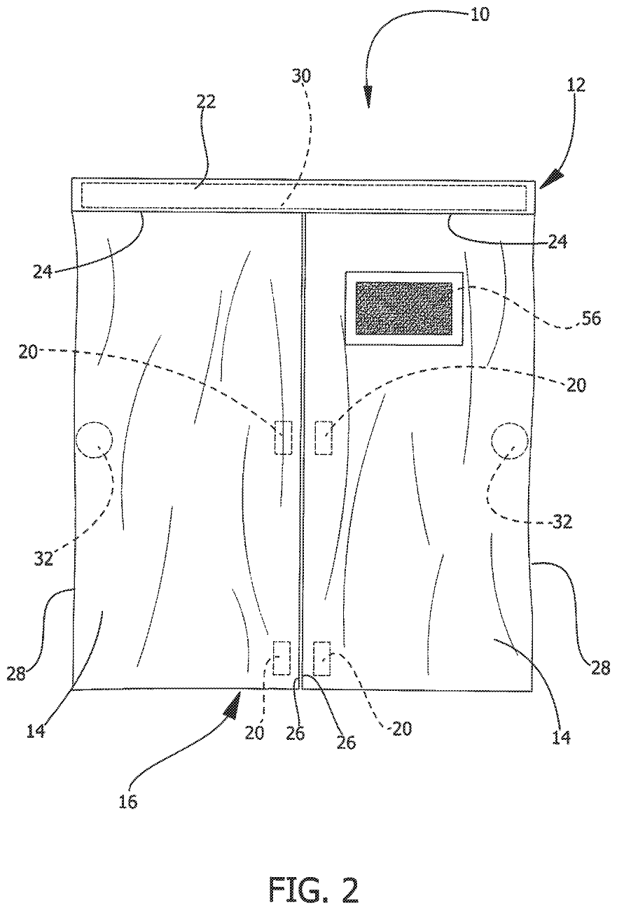

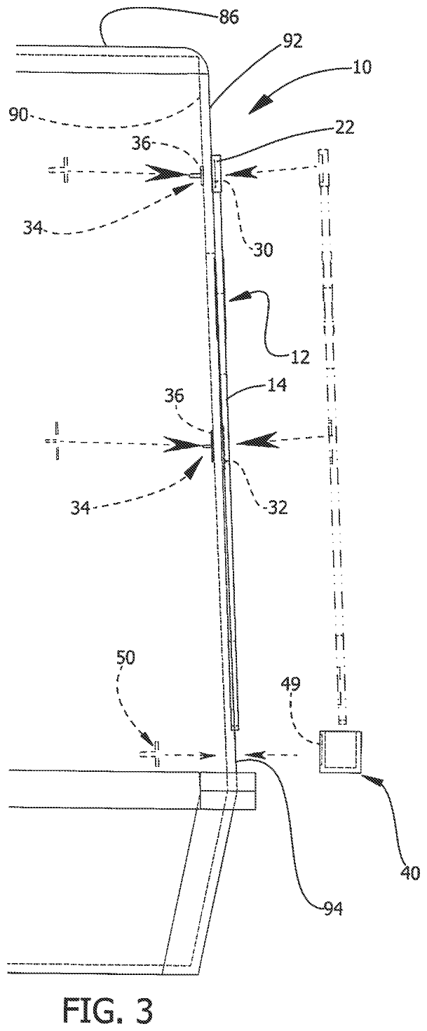

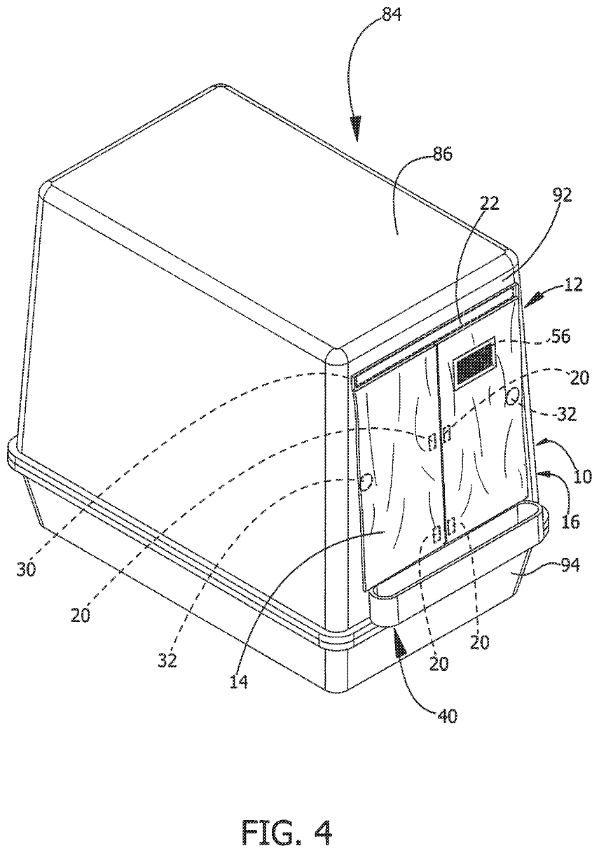

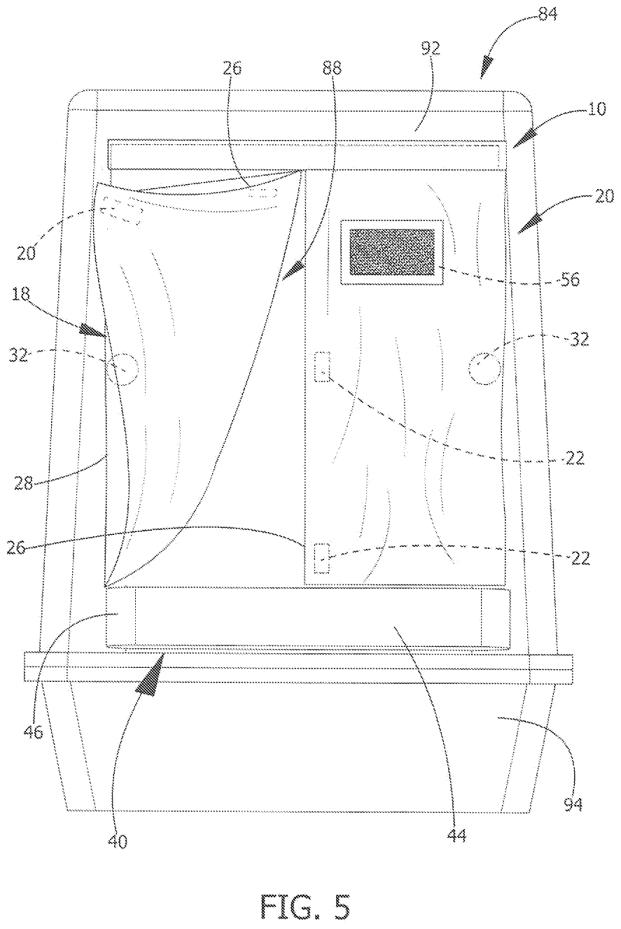

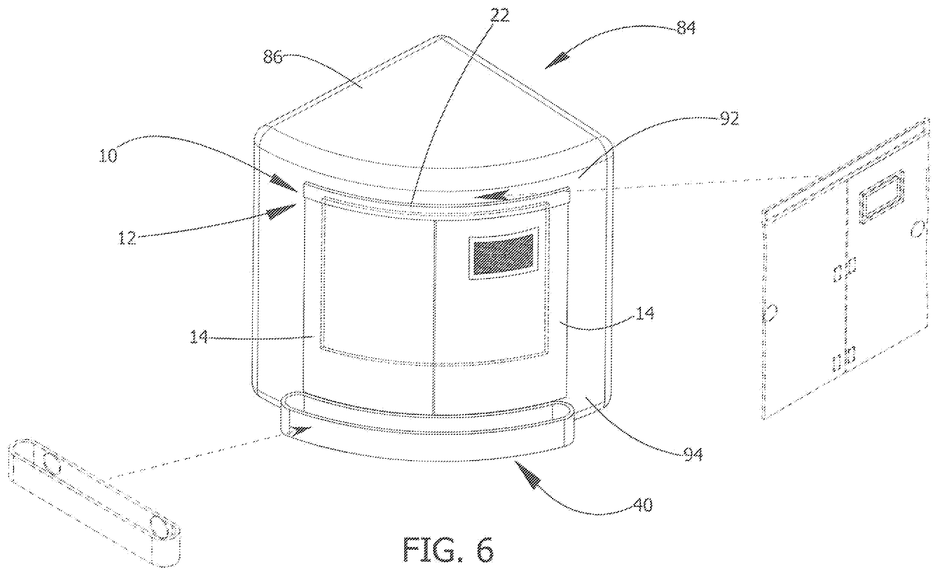

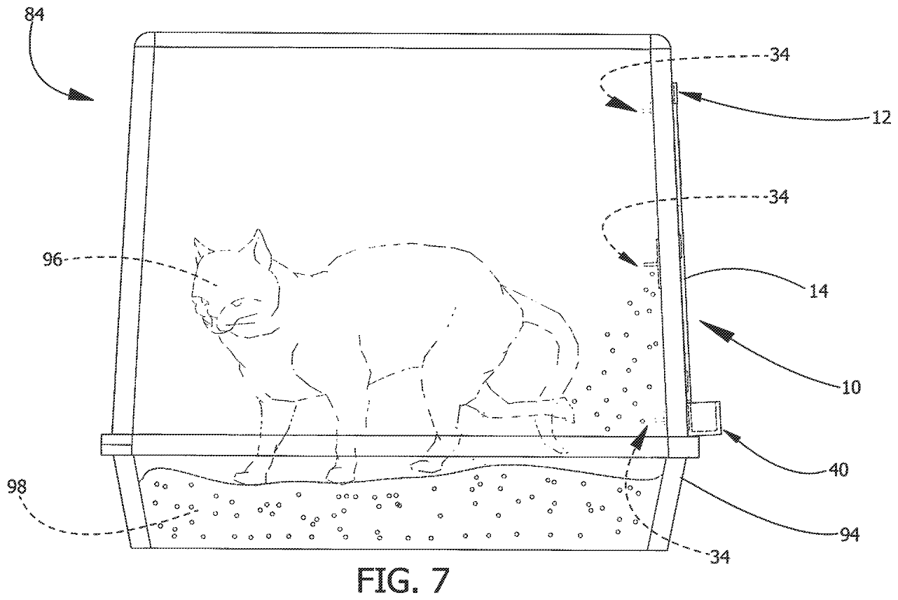

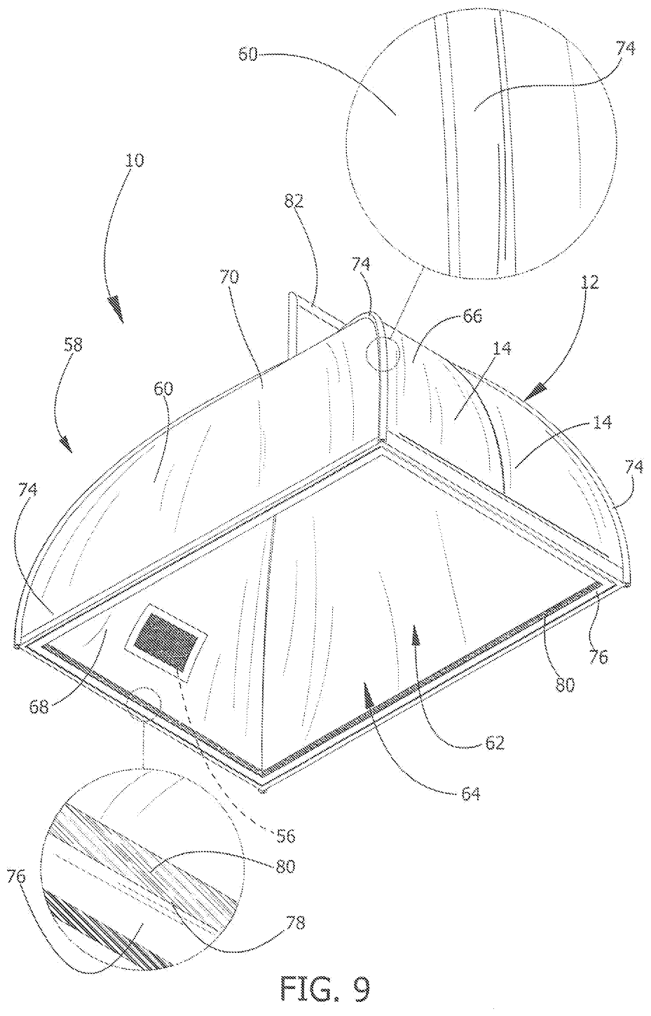

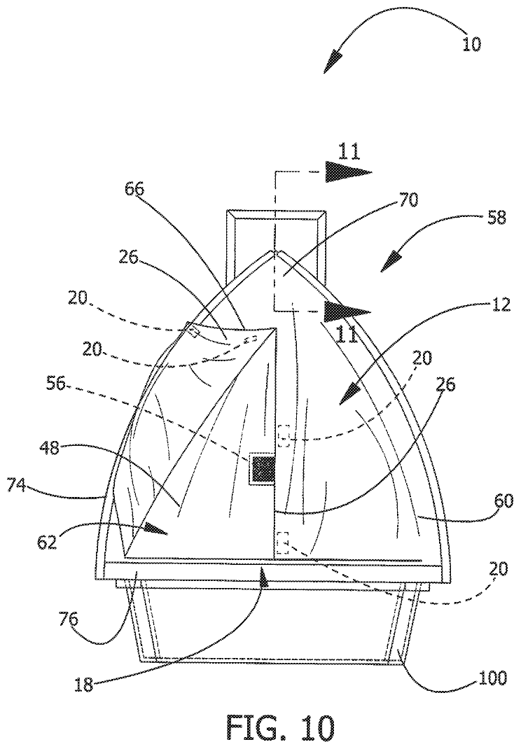

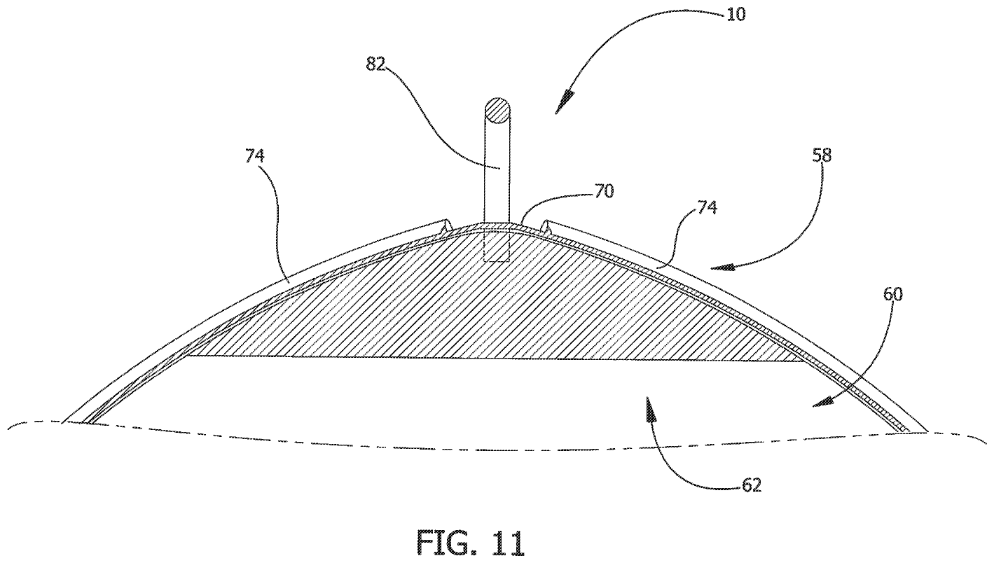

With reference now to the drawings, and in particular to FIGS. 1 through 11 thereof, a new litter box cover embodying the principles and concepts of an embodiment of the disclosure and generally designated by the reference numeral 10 will be described.

As best illustrated in FIGS. 1 through 11, the litter containment system 10 generally comprises a covering 12 that has a pair of curtains 14 which are laterally spaced with respect to each other. The pair of curtains 14 is positionable in a closed configuration 16 wherein inner edges 26 of the pair of curtains 14 lie in abutment with each other. Each one of a plurality of inner magnets 20 is embedded in an associated curtain 14 of the pair of curtains 14 adjacent to the inner edge 26 of the curtain 14 and is oriented to magnetically fasten the pair of curtains 14 in the closed configuration 16.

In a first embodiment, as shown in FIGS. 1 through 7, the covering 12 further comprises a header 22 which is coupled to the top edge 24 of each curtain 14 and a strip 30 which is embedded in the header 22. The strip 30 comprises a ferromagnetic material and extends between outer edges 28 of the pair of curtains 14. The covering 12 also includes a pair of outer magnets 32, each of which is embedded in an associated curtain 14 of the pair of curtains 14 adjacent to the outer edge 28 of the curtain 14.

The first embodiment includes a plurality of curtain fasteners 34, each of which is securable to the covering 12. Each curtain fastener 34 of the plurality of curtain fasteners 34 comprises a curtain fastener base 36 and a curtain fastener handle 38 which are attached to each other. The curtain fastener base 36 comprises a magnetic material. Each curtain fastener 34 of the plurality of curtain fasteners 34 is positionable such that the plurality of curtain fasteners 34 is configured to secure the covering 12 to a hood 86 of a litter box 84 over an opening 88 in the hood 86. The plurality of curtain fasteners 34 is positionable to magnetically clamp the hood 86 with the strip 30 of the covering 12 and the pair of outer magnets 32 of the covering 12. The curtain fastener bases 36 may have various shapes to correspond to the strip 30 or an associated one of the pair of outer magnets 32. For example, some of the curtain fastener bases 36 may have rectangular shapes with complementary widths to a width of the strip 30. Others of the curtain fastener bases 36 may have circular shapes which are complementary in size and shape to the outer magnets 32.

The covering 12 may be positioned on an exterior surface 92 of the hood 86 while the curtain fasteners 34 are positioned across the hood 86 from the covering 12 on an interior surface 90 of the hood 86. The covering 12 may also be positioned on the interior surface 90 while the curtain fasteners 34 are positioned on the exterior surface 92. In other embodiments, the curtain fasteners 34 do not include curtain fastener handles 38, but a curtain fastener adhesive is connected to the curtain fastener base 36 of each curtain fastener 34. The curtain fastener adhesive attaches the curtain fastener base 36 to the hood 86 of the litter box 84, and the covering 12 is magnetically fastened to the plurality of curtain fasteners 34. The curtain fasteners 34 may also be applied magnetically without an adhesive if the hood 86 comprises the ferromagnetic material.

A trough 40 is positionable below the covering 12. The trough 40 comprises a bottom wall 42 and a perimeter wall 44, and the perimeter wall 44 is coupled to and extends away from the bottom wall 42. The trough 40 is elongated between a pair of end portions 46 of the perimeter wall 44. The trough 40 comprises a bendable material such that the trough 40 is bendable along a plane extending through the pair of end portions 46 of the perimeter wall 44. The trough 40 may comprise, for example, a sheet metal which is bendable to conform to a front end 94 of the litter box 84. A pair of trough magnets 49 is mounted to a rear side 48 of the trough 40 and comprises the magnetic material.

Each one of a pair of trough fasteners 50 is securable to the trough 40 and is configured to secure the trough 40 to the litter box 84. The trough fasteners 50 comprise a trough fastener base 52 and a trough fastener handle 54 which are coupled to each other. The trough fastener bases 52 of the trough fasteners 50 comprise the magnetic material and are positionable to clamp the litter box 84 with the pair of trough magnets 49. In some embodiments, the trough fasteners 50 do not have trough fastener handles 54 but have trough 40 adhesives attached to the trough 40 bases such that the trough 40 bases may be adhered to the front end 94 of the litter box 84 and magnetically fasten to the trough magnets 49. The trough fasteners 50 may also be applied magnetically without an adhesive if the hood 86 comprises the ferromagnetic material.

An odor filter 56 is embedded in one of the pair of curtains 14 and is configured to filter odors from air near the odor filter 56 via adsorption of odor-causing substances in the air. The odor filter 56 comprises activated carbon but may comprise any suitable substance for adsorbing or absorbing odor-causing substances.

In use, the covering 12 of the first embodiment is attached to the hood 86 of the litter box 84 via the curtain fasteners 34 and positioned to cover the opening 88 in the hood 86. The inner magnets 20 maintain the curtains 14 in the closed configuration 16 unless a sufficient force pulls them apart, such as one caused by a cat 96 walking into the curtains 14. When the cat 96 or another obstruction is removed from between the curtains 14, the inner edges 26 of the curtains 14 are brought together again via the inner magnets 20. When litter 98 or other substances in the litter box 84 are cast against the curtains 14, the curtains 14 act to inhibit the litter 98 or other substances out of the litter box 84. The trough 40 may also be positioned on the front end 94 of the litter box 84 and bent to conform to the front end 94. Litter 98 and other substances which spill out of the opening 88 may thereby be collected in the trough 40. To retain the covering 12 in an open configuration 18 with respect to the opening 88 of the hood 86, one of the inner magnets 20 of one or both of the curtains 14 is magnetically fastened to the strip 30 in the header 22 or another ferromagnetic surface. This facilitates access to the interior of the litter box 84, for example, when cleaning the litter box 84.

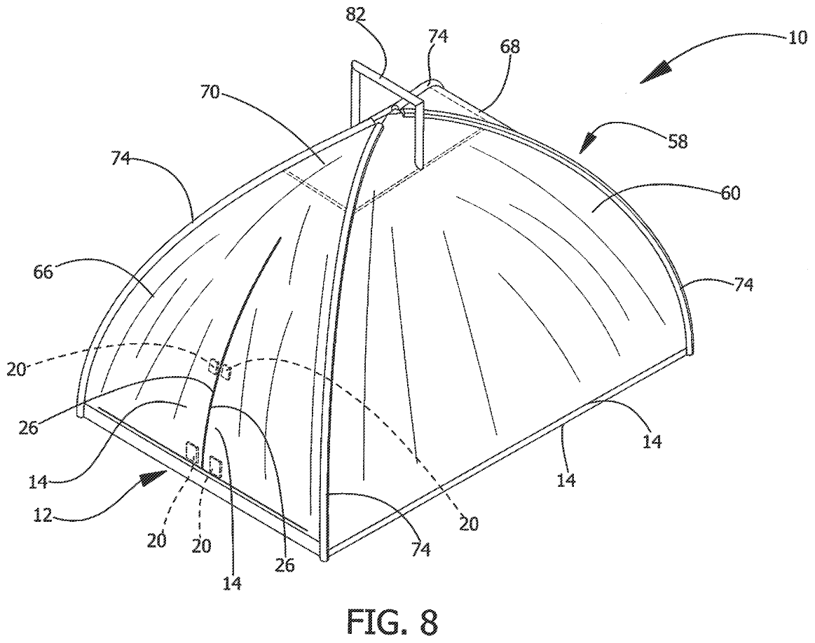

FIGS. 8 through 11 depict a second embodiment of the present invention, which comprises a shroud 58 coupled to the covering 12. The shroud 58 comprises a panel 60 which forms a concavity 62 with an open bottom 64. The covering 12 is coupled to a front portion 66 of the panel 60 and is integrally formed with the panel 60. A plurality of ribs 74 is coupled to the panel 60. The ribs 74 extend radially from a center top portion 70 of the panel 60 to an outer bottom edge 72 of the panel 60. A clamping member 76 is coupled to and extends along the outer bottom edge 72 of the panel 60. The clamping member 76 comprises a resiliently stretchable material such that the clamping member 76 is configured to stretch around and clamp onto a litter basin 100. The panel 60 comprises a flexible material and each rib 74 of the plurality of ribs 74 comprises a bendable material such that the panel 60 and the ribs 74 deform to accommodate stretching of the clamping member 76.

A friction liner 80 is coupled to and extends along an interior side 78 of the clamping member 76. The friction liner 80 comprises a friction enhancing material such that the friction liner 80 is configured to frictionally engage the litter basin 100. The friction enhancing material comprises rubber, but may comprise silicone or the like. A shroud handle 82 is coupled to the plurality of ribs 74 and is positioned at the center top portion 70 of the panel 60. An odor filter 56 is embedded in a rear portion 68 of the panel 60 of the shroud 58 and is configured to filter odors from air near the odor filter 56 via adsorption of odor-causing substances in the air. The odor filter 56 comprises activated carbon but may comprise any suitable substance for adsorbing or absorbing odor-causing substances.

The use of the second embodiment of the present invention is similar to that of the first embodiment, except that the second embodiment mounts to a litter basin 100 that does not have a hood 86. The clamping member 76 is stretched around the litter basin 100 to clamp the shroud 58 over the litter basin 100. The ribs 74 may also comprise the ferromagnetic material such that the covering 12 may be retained in the open configuration 18 by magnetically adhering an inner magnet 20 of one or both curtains 14 to one of the ribs 74.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items 10 following the word are included, but items not specifically mentioned are not excluded. A reference to an element by the indefinite article “a” does not exclude the possibility that more than one of the element is present, unless the context clearly requires that there be only one of the elements.

1. A litter containment system for a litter box, the system comprising:
a covering comprising a pair of curtains which are laterally spaced with respect to each other, the pair of curtains being positionable in a closed configuration wherein inner edges of the pair of curtains lie in abutment with each other;
a plurality of inner magnets, each inner magnet of the plurality of inner magnets being embedded in an associated curtain of the pair of curtains adjacent to the inner edge of the curtain, the plurality of inner magnets being oriented to magnetically fasten the pair of curtains in the closed configuration;
wherein the covering further includes
a header being coupled to a top edge of each curtain of the pair of curtains, and
a strip being embedded in the header, the strip comprising a ferromagnetic material, the strip extending between outer edges of the pair of curtains; and
a plurality of curtain fasteners, each curtain fastener of the pair of curtain fasteners being securable to the covering, each curtain fastener of the plurality of curtain fasteners comprising a curtain fastener base which comprises a magnetic material, each curtain fastener of the plurality of curtain fasteners being positionable such that the plurality of curtain fasteners is configured to secure the covering to a hood of a litter box over an opening in the hood via magnetically fastening to the strip of the covering; and
a trough being positionable below the covering, the trough comprising a bottom wall and a perimeter wall, the perimeter wall being coupled to and extending away from the bottom wall, the trough being elongated between a pair of end portions of the perimeter wall, the trough comprising a bendable material such that the trough is bendable along a plane extending through the pair of end portions of the perimeter wall.

2. (canceled)

3. The system of claim 1, wherein:
the covering further comprises a pair of outer magnets, each outer magnet being embedded in an associated curtain of the pair of curtains adjacent to the outer edge of the curtain; and
the plurality of curtain fasteners being configured to secure the covering to the hood via magnetically fastening to the strip and the pair of outer magnets of the covering.

4. The system of claim 1, wherein each curtain fastener of the plurality of curtain fasteners further comprises a curtain fastener handle, the curtain fastener handle being coupled to the curtain fastener base, said plurality of curtain fasteners being configured to clamp the hood with the strip of the covering to secure the covering to the hood.

5. (canceled)

6. The system of claim 1, further comprising:
a pair of trough magnets being mounted to a rear side of the trough, the pair of trough magnets comprising the magnetic material; and
a pair of trough fasteners, each trough fastener of the pair of trough fasteners being securable to the trough, each trough fastener of the pair of trough fasteners comprising a trough fastener base and a trough fastener handle, the trough fastener handle being coupled to the trough fastener base, the trough fastener base comprising the magnetic material, the pair of trough fasteners being positionable such that the pair of trough fasteners is configured to secure the trough to the litter box under the opening in the hood, the pair of trough fasteners being configured to magnetically clamp the litter box with the pair of trough magnets.

7. The system of claim 1, further comprising an odor filter being embedded in one of the pair of curtains, the odor filter being configured to filter odors from air near the odor filter via adsorption of odor-causing substances in the air.

8. The system of claim 7, wherein the odor filter comprises activated carbon.

9. The system of claim 1, further comprising a shroud being coupled to the covering, the shroud comprising:
a panel forming a concavity, the concavity having an open bottom, the covering being coupled to a front portion of the panel; and
a plurality of ribs being coupled to the panel, the plurality of ribs extending radially from a center top portion of the panel to an outer bottom edge of the panel.

10. The system of claim 9, wherein:
the shroud further comprises a clamping member being coupled to and extending along the outer bottom edge of the panel, the clamping member comprising a resiliently stretchable material such that the clamping member is configured to stretch around and clamp onto a litter basin;
the covering is integrally formed with the panel, the panel comprising a flexible material;
each rib of the plurality of ribs comprises a bendable material; and
the panel and the plurality of ribs deform to accommodate stretching of the clamping member.

11. The system of claim 10, wherein the shroud further comprises a friction liner being coupled to and extending along an interior side of the clamping member, the friction liner comprising a friction enhancing material such that the friction liner is configured to frictionally engage the litter basin.

12. The system of claim 11, wherein the friction enhancing material comprises rubber.

13. The system of claim 9, wherein the shroud further comprises a shroud handle being coupled to the plurality of ribs and being positioned at the center top portion of the panel.

14. The system of claim 9, further comprising an odor filter being embedded in a rear portion of the panel of the shroud, the odor filter being configured to filter odors from air near the odor filter via adsorption of odor-causing substances in the air.

15. The system of claim 14, wherein the odor filter comprises activated carbon.

16. (canceled)

17. A litter containment system for a litter box, the system comprising:
a covering comprising a pair of curtains which are laterally spaced with respect to each other, the pair of curtains being positionable in a closed configuration wherein inner edges of the pair of curtains lie in abutment with each other;
a plurality of inner magnets, each inner magnet of the plurality of inner magnets being embedded in an associated curtain of the pair of curtains adjacent to the inner edge of the curtain, the plurality of inner magnets being oriented to magnetically fasten the pair of curtains in the closed configuration;
wherein the covering further includes
a header being coupled to a top edge of each curtain of the pair of curtains,
a strip being embedded in the header, the strip comprising a ferromagnetic material, the strip extending between outer edges of the pair of curtains, and
a pair of outer magnets, each outer magnet being embedded in an associated curtain of the pair of curtains adjacent to the outer edge of the curtain;
a plurality of curtain fasteners, each curtain fastener of the pair of curtain fasteners being securable to the covering, each curtain fastener of the plurality of curtain fasteners comprising a curtain fastener base and a curtain fastener handle, the curtain fastener handle being coupled to the curtain fastener base, the curtain fastener base comprising a magnetic material, each curtain fastener of the plurality of curtain fasteners being positionable such that the plurality of curtain fasteners is configured to secure the covering to a hood of a litter box over an opening in the hood, the plurality of curtain fasteners being configured to magnetically clamp the hood with the strip of the covering and the pair of outer magnets of the covering;
a trough being positionable below the covering, the trough comprising a bottom wall and a perimeter wall, the perimeter wall being coupled to and extending away from the bottom wall, the trough being elongated between a pair of end portions of the perimeter wall, the trough comprising a bendable material such that the trough is bendable along a plane extending through the pair of end portions of the perimeter wall;
a pair of trough magnets being mounted to a rear side of the trough, the pair of trough magnets comprising the magnetic material; and
a pair of trough fasteners, each trough fastener of the pair of trough fasteners being securable to the trough, each trough fastener of the pair of trough fasteners comprising a trough fastener base and a trough fastener handle, the trough fastener handle being coupled to the trough fastener base, the trough fastener base comprising the magnetic material, the pair of trough fasteners being positionable such that the pair of trough fasteners is configured to secure the trough to the litter box under the opening in the hood, the pair of trough fasteners being configured to magnetically clamp the litter box with the pair of trough magnets; and
an odor filter being embedded in one of the pair of curtains, the odor filter being configured to filter odors from air near the odor filter via adsorption of odor-causing substances in the air, the odor filter comprising activated carbon.

18. The system of claim 16, further comprising:
a shroud being coupled to the covering, the shroud comprising:
a panel forming a concavity, the concavity having an open bottom, the covering being coupled to a front portion of the panel, the covering being integrally formed with the panel, the panel comprising a flexible material;
a plurality of ribs being coupled to the panel, the plurality of ribs extending radially from a center top portion of the panel to an outer bottom edge of the panel, each rib of the plurality of ribs comprising a bendable material;
a clamping member being coupled to and extending along the outer bottom edge of the panel, the clamping member comprising a resiliently stretchable material such that the clamping member is configured to stretch around and clamp onto a litter basin, the panel and the plurality of ribs deforming to accommodate stretching of the clamping member;
a friction liner being coupled to and extending along an interior side of the clamping member, the friction liner comprising a friction enhancing material such that the friction liner is configured to frictionally engage the litter basin, the friction enhancing material comprising rubber, and
a shroud handle being coupled to the plurality of ribs and being positioned at the center top portion of the panel; and
an odor filter being embedded in a rear portion of the panel of the shroud, the odor filter being configured to filter odors from air near the odor filter via adsorption of odor-causing substances in the air, the odor filter comprising activated carbon.
